(19) United States
(12) Patent Application Publication
(10) Pub. No.: US 2006/0033082 A1
(43) Pub. Date: Feb. 16, 2006

(54) Glow-in-the-dark ceramic

(76) Inventor: Hong Yi Gao, Monterey Park, CA (US)

Correspondence Address: JOE NIEH, 18760 E. AMAR ROAD #204, WALNUT, CA, 91789, US

(21) Appl. No.: 10/915,974

(22) Filed: Aug. 11, 2004

(51) Int. Cl. C03C 8/00; C03C 14/00; C09K 11/08; C09K 11/77; D06L 3/12; B05D 7/00; B05D 3/02

(52) U.S. Cl. 252/301.4 F; 252/301.4 R; 501/32; 501/14; 427/157; 427/372.2; 427/212

(57) ABSTRACT

A composition of material for making a glow-in-the-dark powder and glaze as well as a process for manufacturing a glow-in-the-dark ceramic. The glow-in-the-dark powder consists of aluminum oxide, strontium carbonate, rare earth, and carbon. The glow-in-the-dark glaze consists of red lead, quartz, zinc oxide, glaze melting block, calcite, Suzhou earth, stannic oxide, limestone, and the glow-in-the-dark powder. The glow-in-the dark powder is first sintered and then grinded to fine powder. The powder is then added to the glow-in-the-dark glaze and stirred vigorously to form a paste that can be applied to ceramic products which are to be sintered to form the final glow-in-the-dark ceramic products.

### BACKGROUND

1. Field of Invention

The present invention relates generally to glow-in-the-dark ceramics. More specifically, the present invention relates to a glow-in-the-dark powder and glaze and a process for fabricating the glow-in-the-dark ceramic at high temperatures.

2. Description of Related Art

Existing glow-in-the-dark ceramic products are generally made by painting the finished ceramic product with glow-in-the-dark paint. This technique is ineffective due to the short period that the glow-in-the-dark paint will glow after exposure to light. Furthermore, the glow-in-the-dark paint only gives out a faint glow that is not useful besides for novelty purposes.

### BRIEF SUMMARY OF THE INVENTION

The present invention is a technology for making glow-in-the-dark ceramic. This technology includes the composition of material for making glow-in-the-dark powder and glaze as well as the process for manufacturing the glow-in-the-dark ceramic.

The glow-in-the-dark powder consists of aluminum oxide, strontium carbonate, rare earth, and carbon. The glow-in-the-dark glaze consists of red lead, quartz, zinc oxide, glaze melting block, calcite, Suzhou earth, stannic oxide, limestone, and the glow-in-the-dark powder. The glow-in-the dark powder is first sintered and then grinded to a fine powder. The powder is then added to the glow-in-the-dark glaze and stirred vigorously to form a paste that can be applied to ceramic products which are then sintered to form the final glow-in-the-dark ceramic products.

### DETAILED DESCRIPTION OF THE PREFERRED EMBODIMENT

The following description are meant to be illustrative only and not limiting. Other embodiments of this invention will be apparent to those of ordinary skill in the art in view of this description.

The glow-in-the-dark ceramic is formed by mixing a glow-in-the-dark powder into a glow-in-the-dark glaze to be applied to a ceramic product which is then sintered to form the final glow-in-the-dark ceramic product.

In the preferred embodiment, the glow-in-the-dark powder consists of 37 grams of aluminum oxide, 29 grams of strontium carbonate, 23 grams of rare earth, and 3 grams of carbon. Naturally, similar proportions of the ingredients may be mixed to achieve the desired quantity. The glow-in-the-dark powder is sintered at temperatures ranging from 800 degrees Celsius to 950 degrees Celsius for 30 to 60 minutes. After the glow-in-the-dark powder is sintered, it is grinded to a fine powder of less than 200 mesh. The fine glow-in-the-dark powder is then added to the glow-in-the-dark glaze.

In the preferred embodiment, the glow-in-the-dark glaze consists of 10 grams of red lead, 16 grams of quartz, 3 grams of zinc oxide, 4 grams of glaze melting block, 7 grams of calcite, 4 grams of Suzhou earth, 18 grams of stannic oxide, 15 grams of limestone, and 15.7 grams of the fine glow-in-the-dark powder. Of course, similar proportions of the ingredients may be mixed to achieve the desired quantity. The glow-in-the-dark glaze is stirred vigorously to form a paste. The glow-in-the-dark paste is then applied to ceramic products which are then sintered to form the final glow-in-the-dark ceramic products. The ceramic products with the glow-in-the-dark paste are sintered at a temperature of 1100 degrees Celsius to 1160 degrees Celsius for approximately 8 hours. The preferred temperature for sintering the ceramic products with the glow-in-the-dark paste is 1132 degrees Celsius.

The glow-in-the-dark glaze is the only glow-in-the-dark glaze that can withstand the high temperature of sintering. No known existing glaze can sustain the high temperature of sintering. The glow-in-the-dark powder and glaze are safe for human contact and does not have any radiation and will not irritate the human skin and eyes. The glow-in-the-dark ceramic manufactured in accordance with the present invention has a long glowing time of approximately 8 to 12 hours. This extraordinary property enables the glow-in-the-dark ceramic to be used for decorative and safety lighting of gardens and walkways at night, saving electricity cost and eliminate installation of electrical wires.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A glow-in-the-dark powder consisting:
aluminum oxide;
strontium carbonate;
rare earth; and
carbon.

2. A glow-in-the-dark powder as in claim 1, wherein said glow-in-the-dark powder consists of 37 grams of aluminum oxide, 29 grams of strontium carbonate, 23 grams of rare earth, and 3 grams of carbon.

3. A glow-in-the-dark powder as in claim 1, wherein said glow-in-the-dark powder is sintered and grinded to a fine powder.

4. A glow-in-the-dark powder as in claim 3, wherein said glow-in-the-dark powder is sintered and grinded to a fine powder of less than 200 mesh.

5. A glow-in-the-dark glaze consisting:
red lead;
quartz;
zinc oxide;
glaze melting block;
calcite;
Suzhou earth;
stannic oxide;
limestone;
aluminum oxide;
strontium carbonate;
rare earth; and
carbon.

6. A glow-in-the-dark glaze as in claim 5, wherein said glow-in-the-dark glaze consists of 10 grams of red lead, 16 grams of quartz, 3 grams of zinc oxide, 4 grams of glaze melting block, 7 grams of calcite, 4 grams of Suzhou earth, 18 grams of stannic oxide, 15 grams of limestone, and 15.7 grams of a mixture of aluminum oxide, strontium carbonate, rare earth, and carbon.

7. A process for making glow-in-the-dark ceramic comprising the steps of:
mixing a glow-in-the-dark powder into a glow-in-the-dark glaze;
applying said mixture of glow-in-the-dark powder and glow-in-the-dark glaze to a ceramic product; and
sintering said ceramic product to form a glow-in-the-dark ceramic product.

8. A process for making glow-in-the-dark ceramic as in claim 7, wherein said glow-in-the-dark powder consists of aluminum oxide, strontium carbonate, rare earth, and carbon.

9. A process for making glow-in-the-dark ceramic as in claim 8, wherein said glow-in-the-dark powder consists of 37 grams of aluminum oxide, 29 grams of strontium carbonate, 23 grams of rare earth, and 3 grams of carbon.

10. A process for making glow-in-the-dark ceramic as in claim 7, wherein said glow-in-the-dark glaze consists of red lead, quartz, zinc oxide, glaze melting block, calcite, Suzhou earth, stannic oxide, limestone, aluminum oxide, strontium carbonate, rare earth, and carbon.

11. A process for making glow-in-the-dark ceramic as in claim 10, wherein said glow-in-the-dark glaze consists of 10 grams of red lead, 16 grams of quartz, 3 grams of zinc oxide, 4 grams of glaze melting block, 7 grams of calcite, 4 grams of Suzhou earth, 18 grams of stannic oxide, 15 grams of limestone, and 15.7 grams of glow-in-the-dark powder.

12. A process for making glow-in-the-dark ceramic as in claim 7, wherein said glow-in-the-dark powder is sintered at a temperature ranging from 800 degrees Celsius to 950 degrees Celsius for 30 to 60 minutes and grinded into a fine powder of less than 200 mesh.

13. A process for making glow-in-the-dark ceramic as in claim 12, wherein said fine powder of glow-in-the-dark powder is mixed into a glow-in-the-dark glaze and stirred vigorously to form a paste.

14. A process for making glow-in-the-dark ceramic as in claim 13, wherein said paste is applied to a ceramic product and sintered at a temperature of 1100 degrees Celsius to 1160 degrees Celsius for approximately 8 hours.

15. A process for making glow-in-the-dark ceramic as in claim 13, wherein said paste is applied to a ceramic product and sintered at a temperature of 1132 degrees Celsius for approximately 8 hours.
